(19) United States
(12) Patent Application Publication
(10) Pub. No.: US 2019/0318614 A1
(43) Pub. Date: Oct. 17, 2019

(54) RF REMOTE CONTROLLING DEVICE

(71) Applicant: PUC Perfect Union Co., Ltd., New Taipei (TW)

(72) Inventor: Ching Chan, New Taipei (TW)

(21) Appl. No.: 15/953,612

(22) Filed: Apr. 16, 2018

(51) Int. Cl. G08C 17/02

(52) U.S. Cl. CPC G08C 17/02; H04B 1/38

(57) ABSTRACT

A remote controlling device includes a host including a power cord, a power socket, a 433 MHz wireless transceiver, and an MCU; and a battery powered remoter control includes buttons, an MCU, a 433 MHz wireless transceiver, and an LCD. In response to pressing the button, the MCU of the remoter control processes an instruction and instructs the 433 MHz wireless transceiver of the remoter control to send out an RF signal representing the instruction to the 433 MHz wireless transceiver of the host, the 433 MHz wireless transceiver of the host sends the received RF signal to the MCU of the host, and the MCU of the host reads the RF signal and causes an electrical device connected to the power socket to respond.

### BACKGROUND OF THE INVENTION

### 1. Field of the Invention

The invention relates to remote controls and more particularly to a radio frequency (RF) remote controlling device for a mechanical fan or electric heater having improved characteristics including close loop control and two-way communications.

### 2. Description of Related Art

Conventional remote controls are infrared (IR) remote controls which have the following disadvantages: only one way control due to its open loop arrangement (i.e., not close loop), short distance control, and unreliable operation.

Thus, the need for improvement still exists.

### SUMMARY OF THE INVENTION

It is therefore one object of the invention to provide a remote controlling device comprising a host including a power cord, a power socket, a 433 MHz wireless transceiver, and a microcontroller unit (MCU); and a battery powered remoter control includes a plurality of buttons, an MCU, a 433 MHz wireless transceiver, and an LCD; wherein in response to pressing the button, the MCU of the remoter control processes an instruction and instructs the 433 MHz wireless transceiver of the remoter control to send out a radio frequency (RF) signal representing the instruction to the 433 MHz wireless transceiver of the host, the 433 MHz wireless transceiver of the host sends the received RF signal to the MCU of the host, and the MCU of the host reads the RF signal and causes a mechanical fan connected to the power socket to respond.

It is therefore another object of the invention to provide a remote controlling device comprising a host including a power cord, a power socket, a 433 MHz wireless transceiver, and a microcontroller unit (MCU); and a battery powered remoter control includes a plurality of buttons, an MCU, a 433 MHz wireless transceiver, and an LCD; wherein in response to pressing the button, the MCU of the remoter control processes an instruction and instructs the 433 MHz wireless transceiver of the remoter control to send out a radio frequency (RF) signal representing the instruction to the 433 MHz wireless transceiver of the host, the 433 MHz wireless transceiver of the host sends the received RF signal to the MCU of the host, and the MCU of the host reads the RF signal and causes an electric heater connected to the power socket to respond.

The above and other objects, features and advantages of the invention will become apparent from the following detailed description taken with the accompanying drawings.

### BRIEF DESCRIPTION OF THE DRAWINGS

FIG. 1 is a perspective view of a remote controlling device according to the invention;

FIG. 2 is a block diagram of the remote controlling device for a mechanical fan;

FIG. 3 is another perspective view of the remote controlling device; and

FIG. 4 is a block diagram of a remote controlling device of the invention for an electric heater.

### DETAILED DESCRIPTION OF THE INVENTION

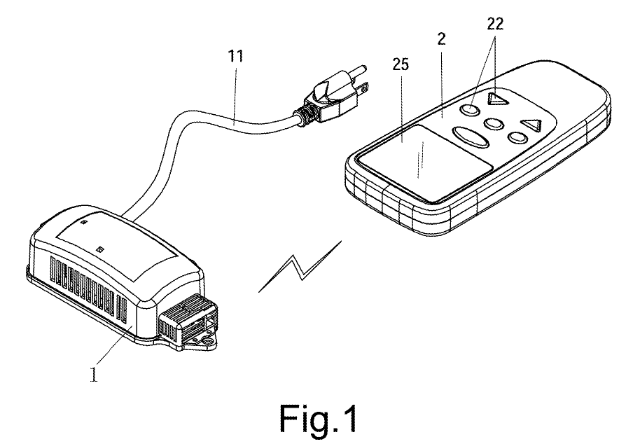

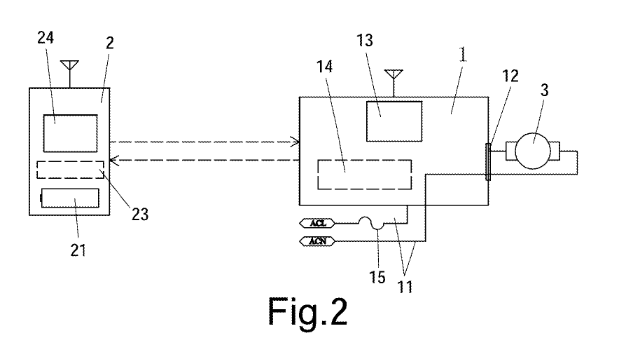

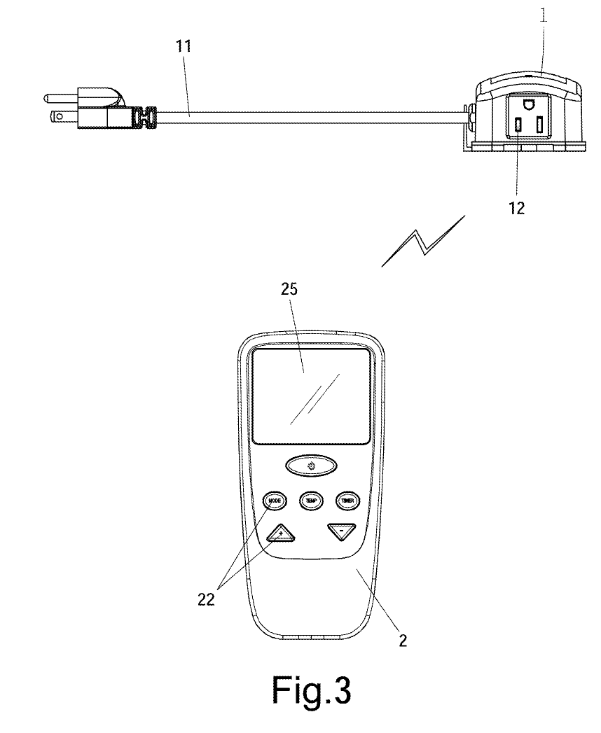

Referring to FIGS. 1 to 3, a remote controlling device for a mechanical fan 3 in accordance with the invention comprises the following components as discussed in detail below.

A host 1 includes a power cord 11 having an electrical plug (not numbered) adapted to insert into an electrical socket on an alternating current (AC) power supply in a building, a power socket 12 adapted to connect to a power cord (not shown) of the mechanical fan 3, a 433 MHz wireless transceiver 13, and a microcontroller unit (MCU) 14.

A remoter control 2 includes a battery 21, a plurality of buttons 22 on a surface, an MCU 23, a 433 MHz wireless transceiver 24, and a display (e.g., liquid crystal display (LCD) 25.

For operating the mechanical fan 3, a user may press one or more buttons 22 to input an instruction. The MCU 23 processes the instruction and instructs the 433 MHz wireless transceiver 24 to send out a radio frequency (RF) signal representing the instruction to the 433 MHz wireless transceiver 13 wirelessly. After receiving the RF signal, the 433 MHz wireless transceiver 13 sends the RF signal to the MCU 14 which in turn reads the RF signal and causes the mechanical fan 3 to respond accordingly. The response can be an ON, an OFF, a setting of time, a change of rotation speed of the mechanical fan 3, etc.

Further, the response is encoded into an RF signal by the MCU 14. And in turn, the MCU 14 sends the RF signal representing the response to the 433 MHz wireless transceiver 13. And in turn, the 433 MHz wireless transceiver 13 transmits the RF signal to the 433 MHz wireless transceiver 24. After receiving the RF signal, the 433 MHz wireless transceiver 24 sends it to the MCU 23. Then the MCU 23 decodes the RF signal and sends information contained in the decoded RF signal to the LCD 25 for representation.

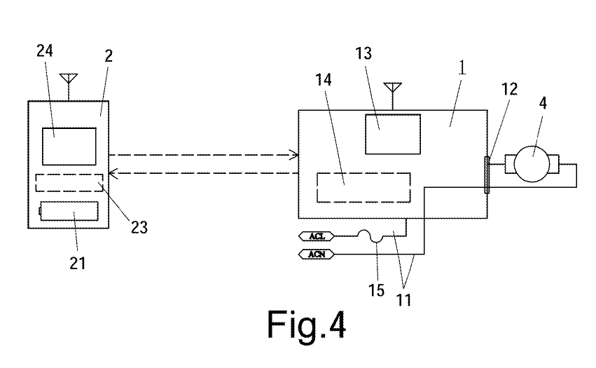

Referring to FIG. 4, a remote controlling device for an electric heater 4 in accordance with the invention is shown. The characteristics of the remote controlling device are substantially the same as that shown in FIGS. 1 to 3 except the following: An overcurrent protection member (e.g., fuse) 15 is provided in series with the power cord 11. Further, a user may press one or more buttons 22 to set temperature for starting the electric heater 4 or temperature for stopping the electric heater 4. Furthermore, a dry contact (not shown) is incorporated in the MCU 14 for controlling on/off and setting of time of the electric heater 4, etc.

While the invention has been described in terms of preferred embodiments, those skilled in the art will recognize that the invention can be practiced with modifications within the spirit and scope of the appended claims.

1. A remote controlling device comprising:
a host including a power cord, a power socket, a 433 MHz wireless transceiver, and a microcontroller unit (MCU); and
a battery powered remote control includes a plurality of buttons, an MCU, a 433 MHz wireless transceiver, and a display;
wherein, in response to pressing one or more of the buttons, the MCU of the remote control processes an instruction and instructs the 433 MHz wireless transceiver of the remote control to send out a first radio frequency (RF) signal representing the instruction to the 433 MHz wireless transceiver of the host, the 433 MHz wireless transceiver of the host sends the received first RF signal to the MCU of the host, and the MCU of the host reads the first RF signal and causes a mechanical fan connected to the power socket to respond according to the instruction and wherein a response signal confirming response of the mechanical fan to the instruction is encoded into a second RF signal by the MCU of the host, the MCU of the host sends the second RF signal representing the confirming response to the 433 MHz wireless transceiver of the host, the 433 MHz wireless transceiver of the host transmits the second RF signal to the 433 MHz wireless transceiver of the remote control, the 433 MHz wireless transceiver of the remote control sends the received second RF signal to the MCU of the remote control, and the MCU of the remote control decodes the second RF signal and sends information contained in the decoded second RF signal and displays the confirming response on the display.

2. (canceled)

3. A remote controlling device comprising:
a host including a power cord, a power socket, a 433 MHz wireless transceiver, and a microcontroller unit (MCU); and
a battery powered remote control includes a plurality of buttons, an MCU, a 433 MHz wireless transceiver, and a display;
wherein in response to pressing one or more of the buttons, the MCU of the remote control processes an instruction and instructs the 433 MHz wireless transceiver of the remote control to send out a first radio frequency (RF) signal representing the instruction to the 433 MHz wireless transceiver of the host, the 433 MHz wireless transceiver of the host sends the received first RF signal to the MCU of the host, and the MCU of the host reads the first RF signal and causes an electric heater connected to the power socket to respond according to the instruction and wherein a response signal confirming response of the electric heater to the instruction is encoded into a second RF signal by the MCU of the host, the MCU of the host sends the second RF signal representing the confirming response to the 433 MHz wireless transceiver of the host, the 433 MHz wireless transceiver of the host transmits the second RF signal to the 433 MHz wireless transceiver of the remote control, the 433 MHz wireless transceiver of the remote control sends the received second RF signal to the MCU of the remote control, and the MCU of the remote control decodes the second RF signal and sends information contained in the decoded second RF signal and displays the confirming response on the display.

4. (canceled)

5. The remote controlling device of claim 3, further comprising an overcurrent protection member in series with the power cord.
